(19) United States
(12) Patent Application Publication
(10) Pub. No.: US 2013/0236053 A1
(43) Pub. Date: Sep. 12, 2013

(54) OBJECT IDENTIFICATION SYSTEM AND METHOD

(71) Applicant: TOSHIBA TEC KABUSHIKI KAISHA, Tokyo (JP)

(72) Inventors: Hidehiro NAITO, Shizuoka (JP); Hiroshi SUGASAWA, Miyagi (JP)

(73) Assignee: TOSHIBA TEC KABUSHIKI KAISHA, Tokyo (JP)

(21) Appl. No.: 13/772,070

(22) Filed: Feb. 20, 2013

(30) Foreign Application Priority Data
Mar. 6, 2012 (JP) 2012-049464

(51) Int. Cl. G06K 9/32

(52) U.S. Cl. CPC G06K 9/3241
USPC 382/103

(57) ABSTRACT

According to embodiments, an object identification system is disclosed. The object identification system comprises a dictionary file comprising multiple records, each record including: an object identification code, and one or more standard images, wherein each standard image is related to one of the object identification codes. The object identification system further comprises a computation module configured to calculate a similarity by comparing an image data produced by an image sensor with the standard images in each record, and an identification module configured to identify one or more of the object identification codes based on the calculated similarity. The object identification system further comprises a production module configured to produce a graphical user interface that displays each of one or more standard images that are related to one of the object identification codes specified by a user.

### CROSS-REFERENCE TO RELATED APPLICATION

This application is based upon and claims the benefit of priority from Japanese Patent Application No. 2012-049464, filed Mar. 6, 2012, the entire contents of which are incorporated herein by reference.

### FIELD

Embodiments described herein relate generally to an object identification system which uses standard images of an object.

### BACKGROUND

Recognition technology which identifies commodities from image data is known. This recognition technology compares a dictionary data with the feature value of the image data using algorithms such as the pattern matching method, the minutia method, and frequency analysis. In recent years these recognition technologies are being considered to be used in scanners in supermarkets.

### DESCRIPTION OF THE DRAWINGS

FIG. 1 is a perspective view of a checkout system according to an embodiment.

FIG. 2 is a schematic block diagram of the hardware components of a POS terminal and product readout device according to an embodiment.

FIG. 3 is a schematic drawing of a PLU file data organizational structure according to an embodiment.

FIG. 4 is a schematic drawing of dictionary data in organizational structure according to an embodiment.

FIG. 5 is a function block drawing of a program that is implemented by the POS terminal and product readout device according to an embodiment.

FIG. 6 is a GUI layout for accepting the product selection according to an embodiment.

FIG. 7 is a GUI layout for the dictionary content confirmation according to an embodiment.

FIG. 8 is a GUI layout for displaying a list of the standard image according to an embodiment.

FIG. 9 is a flow chart for selecting product codes implemented by the product readout device program according to an embodiment.

FIG. 10 is an administration flowchart of the standard image implemented by the program of the product readout device according to an embodiment.

### DETAILED DESCRIPTION

According to embodiments, an object identification system is disclosed. The object identification system comprises a dictionary file comprising multiple records, each record including: an object identification code, and one or more standard images, wherein each standard image is related to one of the object identification codes. The object identification system further comprises a computation module configured to calculate a similarity by comparing an image data produced by an image sensor with the standard images in each record, and an identification module configured to identify one or more of the object identification codes based on the calculated similarity. The object identification system further comprises a production module configured to produce a graphical user interface that displays each of one or more standard images that are related to one of the object identification codes specified by a user.

According to additional embodiments, an object identification method is disclosed. The object identification method comprises: receiving an image data produced by an image sensor, and comparing the received image data with a plurality of standard images each related to an object identification code, wherein the plurality of standard images and the object identification codes are stored in a dictionary file. The object identification method further comprises calculating a similarity between the received image data and the standard images related to each object identification code, and identifying one or more of the object identification codes based on the calculated similarity. The object identification method further comprises accepting a user's selection of one of the object identification codes, and producing a graphical user interface that displays the one or more standard images that are related to the selected object identification code.

Hereinafter, further embodiments will be described with reference to the drawings. In the drawings, the same reference numerals denote the same or similar portions, respectively.

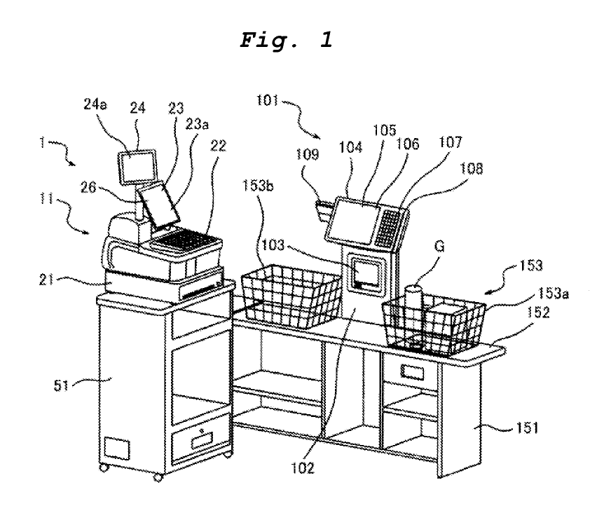

An embodiment will be explained with reference to FIG. 1 to FIG. 10. FIG. 1 is an exterior drawing of a checkout system 1 according to the embodiment. The checkout system 1 includes a POS terminal 11, a drawer 21, a checkout stand 51, a counter 151, and a product readout device 101. The checkout stand 51 includes the POS terminal 11 and the drawer 21 at the top. The drawer 21 has a space for coins and bills inside. The drawer 21 is operated based on signals from the POS terminal 11.

The POS terminal 11 includes a keyboard 22, a display device 23, and a display device 24. The keyboard 11 is an input device for receiving input from the operator. The display device 23 displays information for the operator. The display device 23 includes a touch panel 26 on its surface 23a. This touch panel 26 detects the location where the operators hand has contacted. The display device 24 displays information for the customers. The display device 24 may also have a touch panel 24a on its surface. The POS terminal 11 supports the display device 24 ability to turn. The operator is able to turn the display device 24 in the desired direction.

The product readout device 101 may be placed on the top of the counter 151. The product readout device 101 transmits and receives data to the POS terminal 11. The counter 151 is arranged parallel with the customer aisle. The customer is likely to move along the counter 151. A checkout stand 51 is placed to be downstream of the customer movement direction next to the counter 151. The operators may operate the product readout device 101 and a POS terminal 11 in a space surrounding the counter 151 and the checkout stand 51.

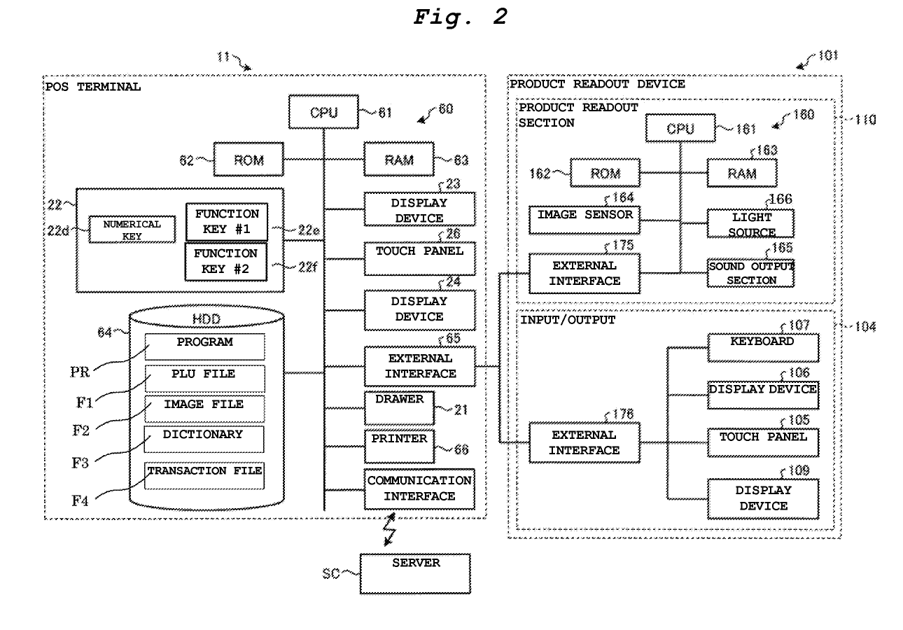

The product readout device 101 includes a housing 102. The housing 102 includes a readout window 103 at the front, a product readout section 110 internally, and an illumination source 166 that is not shown in FIG. 1. Illumination source 166 (see FIG. 2) is placed near the readout window 103 and illuminates the product. The product readout section 110 includes an image sensor 164 as shown in FIG. 2. This image sensor 164 detects light entering from the readout window 103 and converts it into image data.

The housing 102 includes space for an input/output section 104 at the top. The input/output section 104 includes a display device 106, a keyboard 107, a slot 108, and a display device 109. The display device 106 includes a touch panel 105 on its surface. The display device 106 displays information for the operator. The slot 108 includes a card reader to read the magnetic strip on the back of credit and debit cards. The display device 109 displays information for customers.

Customers may place shopping cart 153a on the side of the product readout device 101 and also on the top 152 of the counter 151. The operator has empty shopping cart 153b ready next to the other side of the product readout device 101. The operator removes product G from shopping cart 153a and move product G to the front of the readout window 103. The image sensor 164 receives image data of product G through the readout window 103. After the image sensor 164 receives the image data, the operator places product G into a shopping cart 153b provided in advance. The readout device 101 receives product image data from the operator' s actions.

FIG. 2 is a hardware block diagram of the POS terminal 11 and the product readout device 101. The POS terminal 11 includes a microcomputer 60 for information processing. The microcomputer 60 contains a Central Processing Unit (CPU) 61, a Read Only Memory (ROM) 62, and a Random Access Memory (RAM) 63. A signal line reciprocally connects the CPU 61, the ROM 62, and the RAM 63.

The microcomputer 60 is electronically connected to the drawer 21, the keyboard 22, the display device 23, the display device 24, the touch panel 26, a Hard Disk Drive (HDD) 64, a printer 66, a communication interface 25, and an external interface 65.

The keyboard 22 includes at minimum, numerical key 22d, #1 function key 22e, and #2 function key 22f. The numerical key 22d has multiple numerical keys and operator keys. The printer 66 prints customer receipt information on roll paper.

The hard disc drive 64 stores application programs PR and data including: PLU file F1, image file F2, dictionary F3, and transaction file F4. CPU 61 copies application program PR to RAM 63 at the time of launching the POS terminal 11. The CPU 61 executes application program PR stored in the RAM 63. The CPU 61 reads out data stored in the HDD 64 as needed based on the demand from the application program PR.

The external interface 65 is connected to the product readout device 101. The communications interface 25 is connected to server CS via a network. Server CS has an HDD which stores the master file for PLU file F1. The POS terminal 11 may synchronize periodically with this master file and files F1, F2, F3, and F4.

The product readout device 101 includes the product readout section 110 and the input/output section 104. The product readout section 110 includes a microcomputer 160, the image sensor 164, a sound output section 165, the illumination source 166, and an external interface 175. The microcomputer 160 controls the image sensor 164, the sound output section 165, and the external interface 175. The microcomputer 160 includes the CPU 161, the ROM. 162, and the RAM. 163. The signal line mutually connects the CPU 161, the ROM 162, and the RAM 163. The RAM 163 stores the programs that the CPU 161 executes.

A color CCD or CMOS type sensor module may be used for the image sensor 164. This image sensor 164 creates image data consecutively using a frame rate of 30 frames per second. The image data is stored in the RAM 163. Hereafter, the frame images will be expressed in the order they are created as FI (n) where n is an integer. FI (2) may be assumed to be the frame image created after FI (1).

The sound output 165 includes a sound circuit, speaker, and the like. The sound circuit converts warning sounds and voice messages stored in the RAM 163 beforehand into analog audio signals. The speaker outputs the analog signal which is created in the sound circuit as a sound.

The input/output section 104 includes the touch panel 105, the display device 106, the display device 109, the keyboard 107, and an external interface 176. The external interface 176 connects the input/output section 104 to the product readout section 110 and the POS terminal 11.

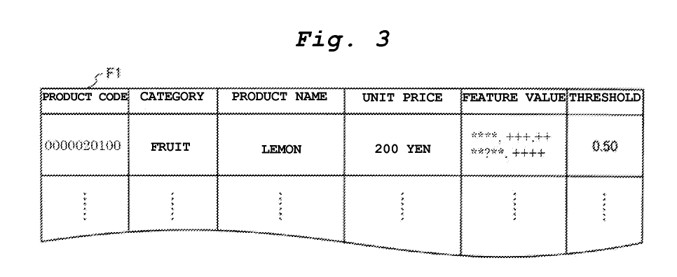

FIG. 3 is a schematic diagram of the data configuration of the PLU file F1. The PLU file F1 is a Price Look Up table programmed with SQL language. Each record of the PLU file F1 may include several field values. The PLU file F1 include at least the product code, product category, product name, unit price, feature value, and threshold field values. The product code is a unique ID to identify product G. This product code may contain a unique ID regulated by UPC (Universal Product Code), EAN (European Article Number), or JAN (Japanese Article Number). PLU file F1 is an assembly of multiple records. The product code is used as a main key, i.e., the product code is a unique ID to identify the records within the same file.

The product category indicates categories such as fruits and vegetables. The feature value is data calculated by CPU 161 based on multiple standard images mentioned later. The threshold is a lower limit of similarity. The CPU 161 may remove products from the candidacy for identification of any product below this threshold value. For example, the CPU 161 can determine, based on this threshold value, when the product loses some of its freshness and changes its surface color as time progresses. In short, when the similarity is below the threshold value, it is determined that the product in the frame image is not proper.

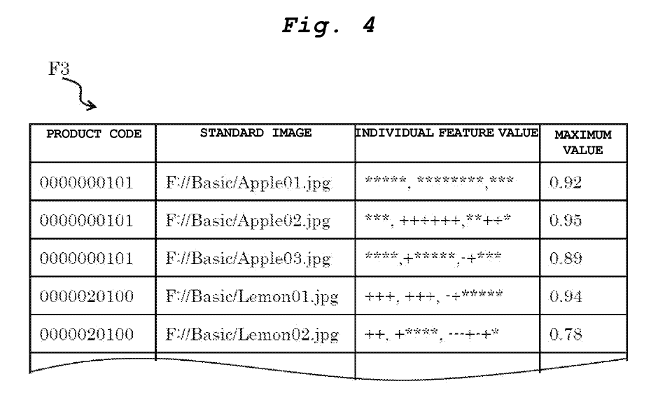

FIG. 4 is a schematic diagram of dictionary F3 data. Dictionary F3 is programmed in the SQL language. Each record in this dictionary F3 includes multiple field values with field names such as product code, standard image, individual feature value, and average. Product code is the same as the PLU file F1 product code. Product code may not have a main key, but multiple records sharing of the same product code as field value.

The standard image is image data taken (for example, by digital camera) of a product and is the standard data to determine product G. The standard image field value includes the same address and file name as image file F2, but not limited to image data of standard images.

The image file F2 stores multiple standard images produced in, for example, Joint Photographic Experts Group (JPEG) format. The standard image has multiple image data of the same product, taken under different conditions. Different conditions means, for example, differing camera directions and differing brightness. The frame image input by image sensor 164 cannot identify which part of the product is included. For that reason, multiple image data taken under various conditions is used as standard data.

The individual feature value is data collected from product G's surface unevenness, pattern, shade, and the like, and is formatted based on the standard images of each record.

The maximum value is a similarity maximum value computed by comparing the individual feature amount and the frame image to every dictionary F3 record. Based on the frame image, within the product code record computed using this system, the maximum value field may be modified. For example, when this system determines the product code is “0000000101”, only the record containing “0000000101” within the dictionary F3 will be updated, this system changes the field value which is the maximum of each record.

The feature value of the PLU file F1 is calculated based on multiple standard images describing address in dictionary F3. For example, we will explain a case in which “0000020100” product code feature value is determined. This system chooses multiple records with product codes from within “0000020100” from the dictionary F3 and calculates the feature value from standard images chosen from the record. The feature value calculated will be stored in the feature value field of the PLU file F1. The feature value may be calculated using individual feature values instead of standard images.

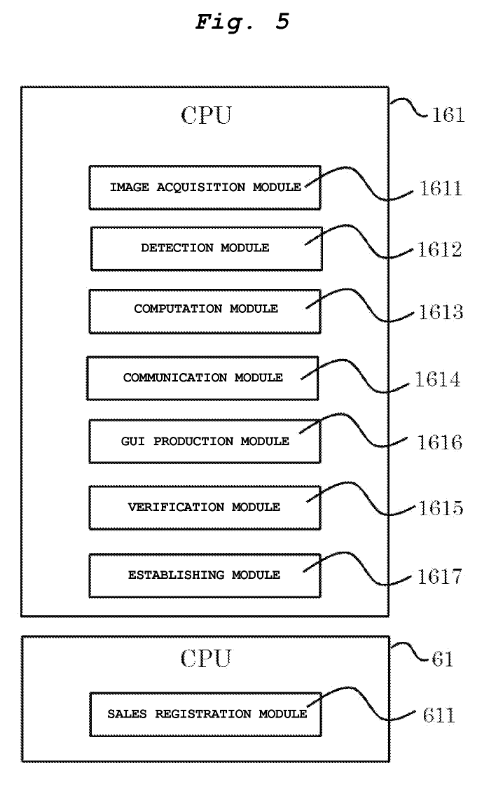

FIG. 5 is a block drawing of a program function executed by the POS terminal 11 and the product readout device 101. The program is executed by the CPU 161 in the product readout device 101. By executing the program, the CPU 161 is configured to include; an image acquisition module 1611, a detection module 1612, a computation module 1613, a GUI production module 1616, a communication module 1614, a verification module 1615, and an establishing module 1617. The ROM 162 stores this program. Program PR executed by the CPU 61 of the POS terminal 11 includes a sales registry section 611.

The image acquisition module 1611 includes the ability to gain frame image FI by controlling the image sensor 164. The image acquisition module 1611 outputs signals to the image sensor 164 and the image sensor 164 will start recording after receiving these signals. The image sensor 164 sends out frame images FI to the RAM 163. The image acquisition section 51 accepts frame images stored in the RAM 163 in order, for example, frame image FI (1), frame image FI (2), etc.

The detection module 1612 detects product G in the frame image using pattern matching technology and extracts an outline from frame image (m) binary data. Next, the detection module 1612 extracts an outline from frame image (m-g) binary data. By comparing these outlines, a product detection section 52 detects product G from frame image (m), where m and g are integers.

Frame image (m-g) is a background image that can be obtained by the image acquisition module 1611 at a time when product G is not included in the frame image.

The detection module 1612 may be able to detect a product from the skin tone of an operator's hand. When the detection module 1612 detected the skin tone region from the frame image, the detection module 1612 extracts an outline by the binarization of the skin tone region of the frame image and its surrounding. With this outline, the detection module 1612 separately detects a hand outline and other object outline. The detection module 1612 may determine this object to be product G.

The computation module 1613 calculates similarity by comparing feature values of product G included in the frame image with feature value of PLU file F1. In concrete terms, the computation module 1613 obtains a partial or whole image of product G. The computation module 1613 may also obtain image data from inside of the outline extracted by the detection module 1612. Based on the image obtained, the computation module 1613 computes feature value data A. Feature value data A is calculated without consideration of factors such as outline and size to reduce the burden on the CPU 161.

The computation module 1613 calculates similarity by comparing feature value data A and feature data B stored in PLU file F1. It is defined that when comparing, identical feature values have a similarity of 100% or 1.0. The computation module 1613 may calculate feature values by weighing such factors as color tone, surface unevenness, and surface pattern. This feature value is an absolute judgment.

Also, the computation module 1613 may calculate similarity by comparing similarity feature value data A and the individual feature value of the dictionary file F3. Furthermore, the computation module 1613 may calculate similarity by comparing the frame image with the standard images of the dictionary F3.

This technology recognizing objects from image data is called “Generic Object Recognition” as explained in:

Kenji Yanai “The Current State and Future Directions of Generic Object Recognition”, Transactions of Information Processing Society of Japan, Vol. 48, No. SIG16 (accessed Aug. 10, 2010 at http://mm.cs.uec.ac.jp/IPSJ-TCVIM-Yanai.pdf); and

Jamie Shotton et al. “Semantic Texton Forests for Image Categorization and Segmentation” (accessed Aug. 10, 2010 at http://citeseerx.ist.psu.edu/viewdoc/download?doi=10.1.1.145.336&rep=repl&type-pdf). Each of these references is hereby incorporated by reference as if set forth herein in their entirety.

This embodiment may use relative evaluation as a similarity. When PLU file F1 has five different product records, computation module 1613 calculates each similarity as an absolute judgment by comparing the product G and the similarity of five records. Each similarity is referred to as GA, GB, GC, GD, and GE. A relative assessment of the similarity will be calculated using logic. For example, GA/(GA+GB+GC+GD+GE).

The communication module 1614 sends a product code selected based on similarity and sales number to the POS terminal 11. In concrete terms, the communication module 1614 extracts product codes of high similarity from PLU file F1 based on the similarity calculated by the computation module 1613. Also, a communication module 1618 determines whether the frame image F1 product is in a proper state or not by comparing the product code similarity with the threshold of the PLU file F1. When the product in the frame image is in a proper state, communication module 1618 sends the product code to the POS terminal 11.

The GUI production module 1616 produces a graphical user interface to send to the display device 106. This GUI contains a selection GUI (described later), a verification GUI, and a list GUI.

The verification module 1616 sums up the record numbers of each product code from dictionary F3. The verification module 1616 obtains the necessary information from PLU file F1 to produce the verification GUI and sends it to the GUI production module 1616.

The establishing module 1617 produces a standard image list for every product code. By the operator selecting a product code in the verification GUI, the establishing module 1617 collects the necessary information from image file F2 and dictionary F3, and sends it to the GUI production 1616.

A sales registration section 611 executes the process for payment by recording the transaction to transaction file F4 based on the product code and sales number received from the communication module 1614. A record of the transaction is printed on a receipt by the printer 66.

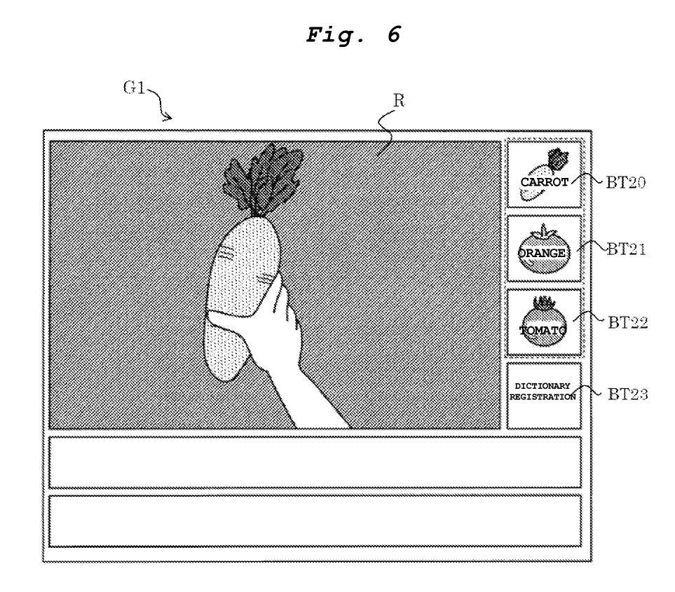

FIG. 6 illustrates the layout of the GUI which receives the product selection. Selection GUI G1 contains area R, BT 20, BT 21, BT 22, and BT 23. Area R is an area to display frame image FI. T 20, BT 21, and BT 22 are buttons to display information of products code with a high similarity degree extracted by the communication module 1614 and the operator's selection. The GUI production module 1616 will layout, in order of descending similarity, product information on the top of buttons BT20, 21, 22. When the operator selects a button, the product code corresponding to this button will be sent to the communication module 1614.

BT 23 is a button to register the frame image displayed in area R to dictionary F3. After the operator 23 selects BT 23, the operator then selects BT 20, BT 21, or BT 22, and the product code and standard image will be registered to dictionary F3. It is also possible for the operator to input the product code using keyboard 107 instead of selecting BT 20, BT 21, or BT 22.

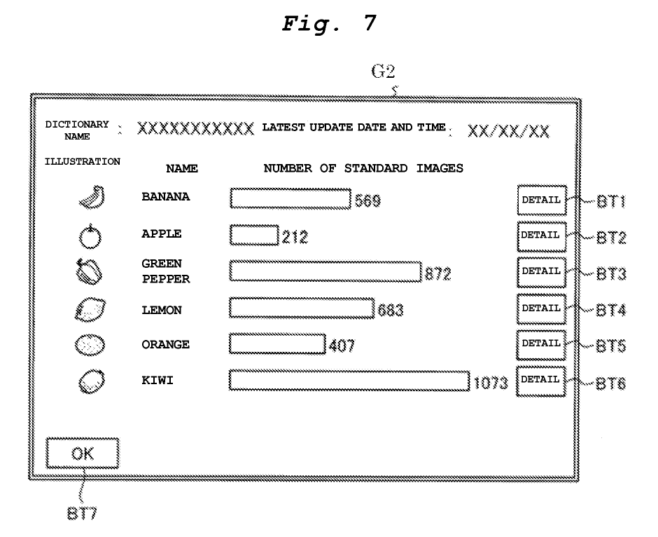

FIG. 7 illustrates the GUI layout for verifying the contents of dictionary F3. Verification GUI G2 displays the results of several product codes registered in dictionary F3 that had been aggregated by product code. The “dictionary name” is the name of dictionary F3. The “latest update” is the date the dictionary F3 is last updated. The “illustration” uses one of the standard images for each product code. A dedicated image saved in PLU file F1 can be used for the illustration for each product code instead of the standard image.

The product name is obtained from PLU file F1. The standard image number is every record of product code counted by the verification module 1615. BT 1 to BT 6 access the list GUI. BT 7 completes the verification in GUI G2. By the operator selecting BT 7, the verification module 1615 will execute dictionary F3 correction.

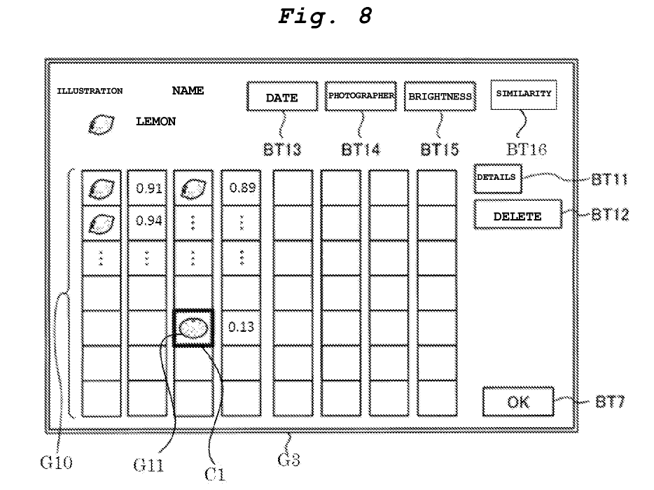

FIG. 8 illustrates a GUI layout which displays standard images for each product code. The establishing module 1617 obtains standard images and maximum field values from the dictionary F3 records, which contain the product codes selected by the operator. Also, an establishing module 1617 produces thumbnails from standard images obtained from image file F2 based on the standard image addresses. The establishing module 1617 sends this data to the GUI production module 1616.

GUI list G3 contains illustrations, product names, thumbnails G10, maximum value, BT 7, BT 13 to 16, BT 11 and BT 12. Illustrations and product names are the same as in the verification GUI. Thumbnails G10 is an area to arrange standard image thumbnails and a maximum value list.

Standard information contains information such as captured date, person who takes the pictures, and illumination degree in its header data. By the operator selecting BT 13 to BT 15, the GUI production module 1616 executes a sorting procedure according to the selected terms. When the operator selects BT 16, the sorting of the list is carried out by sorting the maximum field value of the dictionary F3.

The operator can match the cursor C1 to the intended thumbnail image by touching the screen. BT 11 is a button to display the standard image header data. After the operator selects one of the standard images using the cursor and presses BT 11, a window containing the header data will be displayed at the top of GUI list G3.

BT 12 is a button to erase the standard image. After the operator selects thumbnail G11 by a cursor, which is one of the standard images, and then presses BT 12, the establishing module 1617 will erase the standard image from image file F2 from the corresponding thumbnail G11. BT 7 saves any changes and exits the G3 GUI list display.

In FIG. 8, a list of the standard images of a lemon is displayed. However, the thumbnail image G11 designated by cursor C1 is an orange. The operator can easily find an incorrect standard image like this from the thumbnail image. Also, a maximum value is displayed side by side with the thumbnail. The operator can determine if the image is appropriate or not by searching for a maximum value that is extremely low.

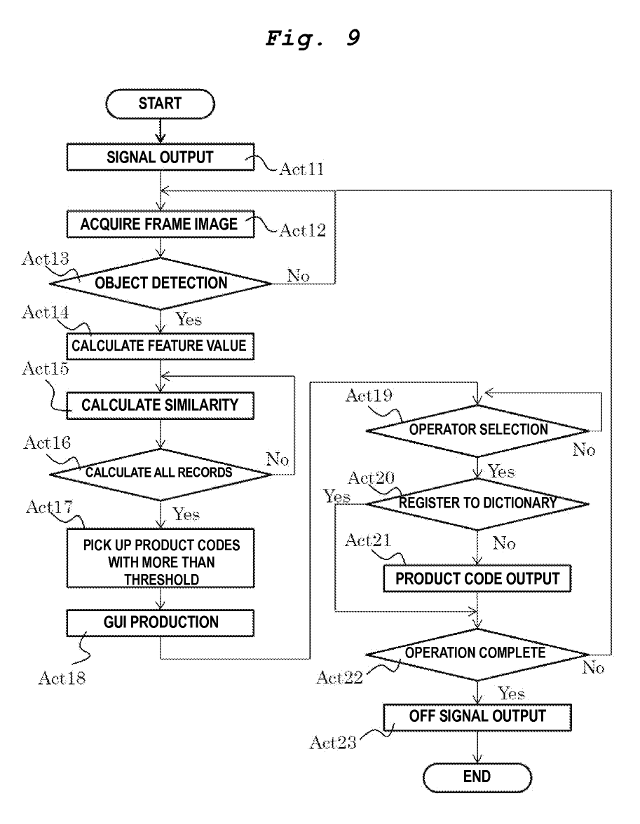

FIG. 9 is a flowchart of the product code identification process executed by the product readout device 101. The CPU 161 of the readout device 101 starts the readout activity. The image acquisition module 1611 sends a signal to the image sensor 164 (Act 11). The image sensor 164 produces a frame image according to the frame rate set in advance and stores it in the RAM 163. The image acquisition section 51 acquires the frame image (m-g), (m) from the RAM 164 (Act 12).

The detection module 1612 checks to see if the product code can be detected from the frame image (m) by comparing frame image (m-g) and frame image (m) (Act 13). When frame image (m) contains no product code, the detecting module 1612 executes the same process to frame image (m+1).

When frame image (m) contains a product code, computation section 1613 calculates feature value data A from frame image (m) (Act 14). The computation module 1613 calculates similarity by comparing feature value data A and the feature value of PLU file F1 (Act 15).

The computation module 1613 checks to see whether similarity is calculated against all of the PLU file F1 record (Act 16). When all similarity is calculated, the communication module 1614 extracts product codes with high similarity values and compares the similarity value to the product code and PLU file F1 threshold. The communication module 1614 picks up product code equal to the threshold or more. (Act 17)

The GUI production module 1616 produces the selection GUI indicated in FIG. 6 (Act 18). The GUI production module 1616 has the option for the operator to press the button (Act 19). The GUI production module 1616 checks to see whether or not the operator has selected button BT 23 (Act 20). When the button chosen by the operator is BT 20 to BT 22, the GUI production module 1616 will reply the applicable product codes to the communication module 1614 (Act 21).

When the button chosen by the operator is BT 23, the GUI production module 1616 records the product code and frame image displayed in area R to dictionary F3. This frame image will be stored in image file F2.

CPU 101 checks if all of the readout processes are completed (Act 22). When all of the readout processes are not completed, the detection module 1615 will acquire a new frame image (Act 12). When all of the readout processes are completed, the image acquisition module 1611 sends an OFF signal to the image sensor 164.

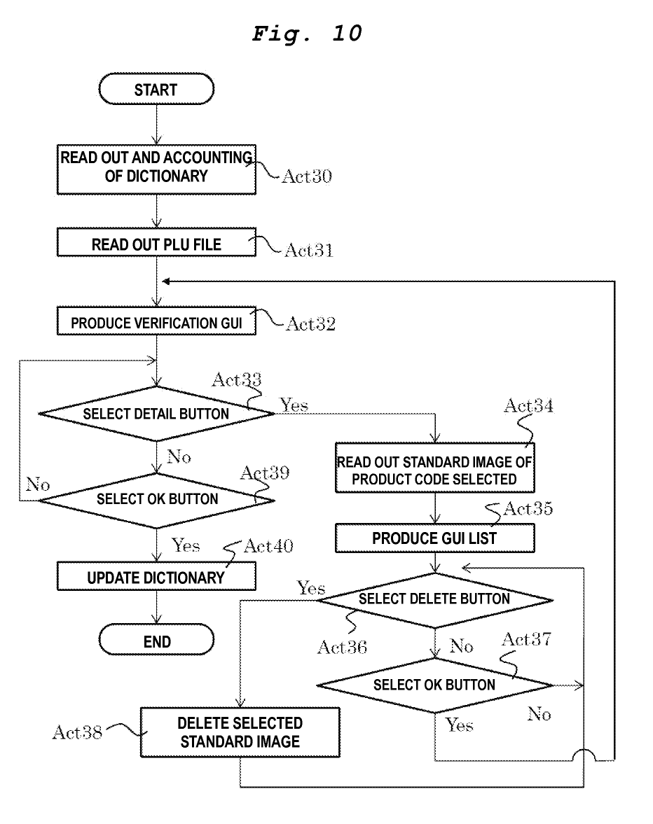

FIG. 10 is a flow chart of standard image management executed by the readout device 101 program. When this program is started up by operator instruction, the verification module 1615 will read out all records from dictionary F3 and count the record numbers from each product code (Act 30). The verification module 1615 will acquire at least the product name from PLU file F1 based on the product code accounted (Act 31). The verification module 1615 transmits this data to the GUI production module 1616.

The GUI production module 1616 produces the verification GUI indicated in FIG. 7 by arranging data received from the verification module 1615 according to a template file determined in advance (Act 32). The GUI production module 1616 waits until the operator selects either one of BT 1 to BT 6 (Act 33). When one is chosen from BT 1 to BT 6, the establishing module 1617 reads out the standard image and the maximum field value from the record of dictionary F3 containing the product code Selected (Act 34). The establishing module 1617 creates a thumbnail image from standard image data from image file F2 and sends to the GUI production module 1616.

The GUI production module 1616 arranges data received from the establishing module 1617 according to a template file determined in advance and produces verification list GUI indicated in FIG. 8 (Act 35). The GUI production module 1616 waits for the operator to select button BT 12 to erase the standard image (Act 36). Operator selects BT 12 by setting cursor C1 on the thumbnail image. The establishing module 1617 erases the selected standard image from image file F2 (Act 38). The relevant record in dictionary F3 will be erased as well. The GUI production module 1616 waits for selection of BT 7 (Act 37). When the operator selects BT 7, CPU 161 will execute Act 32.

In Act 33, the GUI production 1616 waits for the selection of BT 1 to BT 6 or BT 7 which indicates completion (Act 39). When the operator selects BT 7, if the record from dictionary F3 is erased, the verification module 1615 will confirm this deletion. The verification module 1615 will update dictionary F3 including other changes (Act 40).

In the first embodiment, the operator should be able to easily maintain the standard image. There is a possibility that a user will register an incorrect standard image into the hardware. In the first embodiment this problem can be easily eliminated. By resolving this problem, hardware processing speed and distinguishing accuracy should improve.

In the first embodiment, the POS terminal 11 and the product readout device 101 are composed of separate hardware systems, but the disclosure is not limited to these. There can be one hardware system with multiple servers. PLU file F1, image file F2, and dictionary F3 can be stored in a server other than the POS terminal 11. This server can be arranged in a cloud network composed of multiple servers. The PLU file F1, image file F2, and dictionary file F3 database may be modified appropriately according to a system not limited by the first embodiment.

While certain embodiments have been described, these embodiments have been presented by way of example only, and are not intended to limit the scope of the invention. Indeed, the novel embodiments described herein may be embodied in a variety of other forms. Furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An object identification system comprising:
a dictionary file comprising multiple records, each record including:
an object identification code, and
one or more standard images, wherein each standard image is related to one of the object identification codes;
a computation module configured to calculate a similarity by comparing an image data produced by an image sensor with the standard images in each record;
an identification module configured to identify one or more of the object identification codes based on the calculated similarity; and
a production module configured to produce a graphical user interface that displays each of one or more standard images that are related to one of the object identification codes specified by a user.

2. The object identification system according to claim 1, wherein the graphical user interface displays more than one standard images that are related to the object identification code specified by the user

3. The object identification system according to claim 2, wherein the graphical user interface is configured to accept the user's selection of one of the displayed standard images, and
the system further comprises a verification module configured to erase the selected displayed standard image from the dictionary file.

4. The object identification system according to claim 1, wherein each record in the dictionary file includes a maximum similarity calculated by the computation module for each object identification code.

5. The object identification system according to claim 4, wherein the graphical user interface displays a maximum similarity for each displayed standard image.

6. The object identification system according to claim 1, wherein the computation module is configured to calculate the similarity by comparing at least a first feature value calculated from the standard images related to each object identification code with at least a second feature value calculated from the image data produced by the image sensor.

7. The object identification system according to claim 1, further comprising:
a database comprising:
the object identification codes,
a product information for each object identification code, and
a feature value for each object identification code, wherein the feature value is calculated from the one or more standard images related to the corresponding object identification code.

8. The object identification system according to claim 7, wherein
the database contains a lower limit of similarity; and
the identification module is configured to identify one or more object identification codes by comparing the calculated similarity calculated by the computation module for each standard image in each record with the lower limit.

9. The object identification system according to claim 1, wherein the graphical user interface comprises a list of the one or more standard images that are related to the object identification code specified by the user.

10. An object identification method comprising:
receiving an image data produced by an image sensor;
comparing the received image data with a plurality of standard images each related to an object identification code, wherein the plurality of standard images and the object identification codes are stored in a dictionary file;
calculating a similarity between the received image data and the standard images related to each object identification code;
identifying one or more of the object identification codes based on the calculated similarity; and
accepting a user's selection of one of the object identification codes; and
producing a graphical user interface that displays the one or more standard images that are related to the selected object identification code.

11. The object identification method according to claim 10, wherein the graphical user interface displays more than one standard images that are related to the selected object identification code.

12. The object identification method according to claim 11, the method further comprising:
accepting, in the graphical user interface, the user's selection of one of the displayed standard images, and
erasing the selected displayed standard image from the dictionary file.

13. The object identification method according to claim 10, wherein the dictionary file includes a maximum similarity calculated for each object identification code.

14. The object identification method according to claim 13, further comprising displaying, in the graphical user interface, a maximum similarity for each displayed standard image.

15. The object identification method according to claim 10, wherein calculating the similarity comprises comparing at least a first feature value calculated from the standard images related to each object identification code with at least a second feature value calculated from the image data produced by the image sensor.

16. The object identification method according to claim 10, further comprising:
calculating a feature value for each object identification code wherein the feature value is calculated from the one or more standard images related to the corresponding object identification code; and
storing the feature values in a database that includes the object identification codes and a product information for each object identification code.

17. The object identification method according to claim 16, wherein:
the database includes a lower limit of similarity, and
identifying the one or more object identification codes comprises comparing the calculated similarity for each standard image in each record with the lower limit.

18. The object identification method according to claim 10, wherein the graphical user interface comprises a list of the one or more standard images that are related to the object identification code specified by the user.

19. The object identification method according to claim 10, further comprising:
adding the image data produced by the image sensor to the dictionary file.

20. The object identification method according to claim 19, wherein the image data is added to the dictionary file and stored so that it is included in the standard images that are related to an object identification code that is specified by the user.
